(19) United States
(12) Patent Application Publication
(10) Pub. No.: US 2024/0288983 A1
(43) Pub. Date: Aug. 29, 2024

(54) NUMERICAL CONTROL DEVICE, SCREEN CREATION SYSTEM, AND STORAGE MEDIUM FOR STORING INSTRUCTION READABLE BY NUMERICAL CONTROL DEVICE

(71) Applicant: Fanuc Corporation, Minamitsuru-gun, Yamanashi (JP)

(72) Inventors: Shinichi Ozeki, Minamitsuru-gun, Yamanashi (JP); Kouji Osada, Minamitsuru-gun, Yamanashi (JP)

(73) Assignee: Fanuc Corporation, Minamitsuru-gun, Yamanashi (JP)

(21) Appl. No.: 18/568,349

(22) PCT Filed: Jun. 23, 2021
(86) PCT No.: PCT/JP2021/023828

§ 371 Date: Dec. 8, 2023

(51) Int. Cl. G06F 3/0481; G05B 19/409

(52) U.S. Cl. CPC G06F 3/0481; G05B 19/409; G05B 2219/35488

(57) ABSTRACT

A numerical control device for displaying a user interface screen and receiving input of operations from a user acquires setting of operation buttons for display states of composite components included in the user interface screen, determines the arrangement of the operation buttons for the display states of the user interface screen on the basis of the setting of the operation buttons for the display states of the composite components, detects a change in the display states of the user interface screen, and switches the arrangement of the operation buttons in the user interface screen.

### CROSS REFERENCE TO RELATED APPLICATIONS

This is the U.S. National Phase application of PCT/JP2021/023828, filed Jun. 23, 2021, the disclosure of this application being incorporated herein by reference in its entirety for all purposes.

### FIELD OF THE INVENTION

The present invention relates to a screen creation device, a screen creation system, and a computer-readable storage medium.

### BACKGROUND OF THE INVENTION

A numerical controller is a machine that controls a machine tool. The numerical controller is provided with a user interface screen (referred to as a UI screen). The UI screen displays a state of the machine tool and receives input of an operator.

Examples of a control object of the numerical controller include a lathe, a drilling machine, a boring machine, a milling machine, a grinding machine, a machining center, a turning center, and an electric discharge machine. A developer of the UI screen creates the UI screen according to a type of machine tool, a machine configuration of the machine tool, and specifications required by a user.

For example, FIG. 3 of Patent Document 1 is an example of a display screen of a spindle load. This screen displays a state of a machine tool “automatic driving”, a current time “Apr. 23, 2002 21:53:40”, a graph of the spindle load, a program being executed, and screen operation buttons.

Conventionally, there has been dedicated software for an operation screen of a numerical controller. This software provides parts for screen creation. A developer of a UI screen arranges these parts on the UI screen, sets properties (attributes and functions) of the individual parts, and completes the UI screen.

### PATENT DOCUMENT

Patent Document 1: JP 2004-126956 A

### SUMMARY OF THE INVENTION

A UI screen includes a plurality of sub-screens. Each of the sub-screens displays a state according to each purpose. Contents displayed on the sub-screen include tool coordinates, a machining program, a modal state, etc. By displaying the plurality of sub-screens, a plurality of pieces of information can be checked at the same time.

A display state of the UI screen changes according to a mode of the numerical controller, display content of the sub-screen, a selected state of the screen, etc. When the display state changes, operation content of the UI screen also changes. Since an operation button displayed on the UI screen is not fixed, and dynamically changes according to the display state of the UI screen, a creator of the UI screen needs to set the operation button while assuming transition of the display state, which is complicated.

Techniques for simplifying creation of user interfaces are desirable in the field of numerical controllers.

A numerical controller which is an aspect of the disclosure is a numerical controller for displaying a user interface screen. The numerical controller includes a layout determination unit configured to acquire display state information obtained by associating a composite part included in the user interface screen, a display state of the composite part, and setting of an operation button, and determine layout of an operation button for each display state of the user interface screen including the composite part based on the display state of the composite part and setting of the operation button, and an operation button switching unit configured to detect a change in the display state of the user interface screen, and switch layout of the operation button on the user interface screen based on determination of the layout determination unit.

A screen creation system which is an aspect of the disclosure includes a part library configured to store parts included in a user interface screen and a composite part obtained by combining the parts, a display state setting unit configured to receive setting of display state information obtained by associating a composite part included in the user interface screen, a display state of the composite part, and setting of an operation button with respect to the composite part, a layout determination unit configured to determine layout of the operation button for each display state of the user interface screen including the composite part based on the display state of the composite part and setting of the operation button, and an operation button switching unit configured to detect a change in the display state of the user interface screen, and change layout of the operation button displayed on the UI screen in a numerical controller based on determination of the layout determination unit.

A storage medium which is an aspect of the disclosure stores an instruction readable by a numerical controller, the instruction being executed by one or a plurality of processors to acquire display state information obtained by associating a composite part included in a user interface screen of the numerical controller, a display state of the composite part, and setting of an operation button with respect to the composite part, determine layout of the operation button for each display state of the user interface screen including the composite part based on setting of the operation button for each display state of the composite part, detect a change in the display state of the user interface screen, and switch layout of the operation button according to the display state of the user interface screen.

According to one aspect of the invention, it is possible to simplify creation of a user interface.

### BRIEF DESCRIPTION OF DRAWINGS

FIG. 1 is a diagram illustrating a relationship between a screen creation device and a numerical controller;

FIG. 2 is a block diagram of the screen creation device;

FIG. 3 is a diagram illustrating an example of a UI editing screen;

FIG. 4 is a diagram illustrating a relationship between a composite part and a single part;

FIG. 5 is a diagram illustrating an example of a UI screen on which composite parts are arranged;

FIG. 6 is a diagram illustrating a screen configuration of the UI screen;

FIG. 7 is a diagram illustrating layout of operation buttons set in a coordinate display part;

FIG. 8 is a diagram illustrating layout of operation buttons set in an information display part;

FIG. 9 is a diagram illustrating layout of operation buttons set in a program display part;

FIG. 10 is a diagram illustrating layout of operation buttons set in a manual numerical value command part;

FIG. 11 is a diagram illustrating layout of operation buttons set in a fixed phrase part;

FIG. 12 is a block diagram of the numerical controller;

FIG. 13 is a diagram illustrating an example of an operation button layout table;

FIG. 14 is a diagram illustrating layout of operation buttons when a display state is a memory mode and no selection is made;

FIG. 15 is a diagram illustrating layout of operation buttons when the display state is an EDIT mode and a program editing part is selected;

FIG. 16 is a diagram illustrating layout of operation buttons when the display state is an MDI mode and the program editing part is selected;

FIG. 17 is a diagram illustrating layout of operation buttons when the display state is the MDI mode and the fixed phrase part is selected;

FIG. 18 is a diagram illustrating layout of operation buttons when the manual numerical value command part is selected;

FIG. 19 is a diagram illustrating layout of operation buttons when the manual numerical value command part is selected;

FIG. 20 is a flowchart illustrating an operation of a screen creation system; and

FIG. 21 is a hardware configuration diagram of the numerical controller.

A screen creation system 300 of the disclosure will be described below.

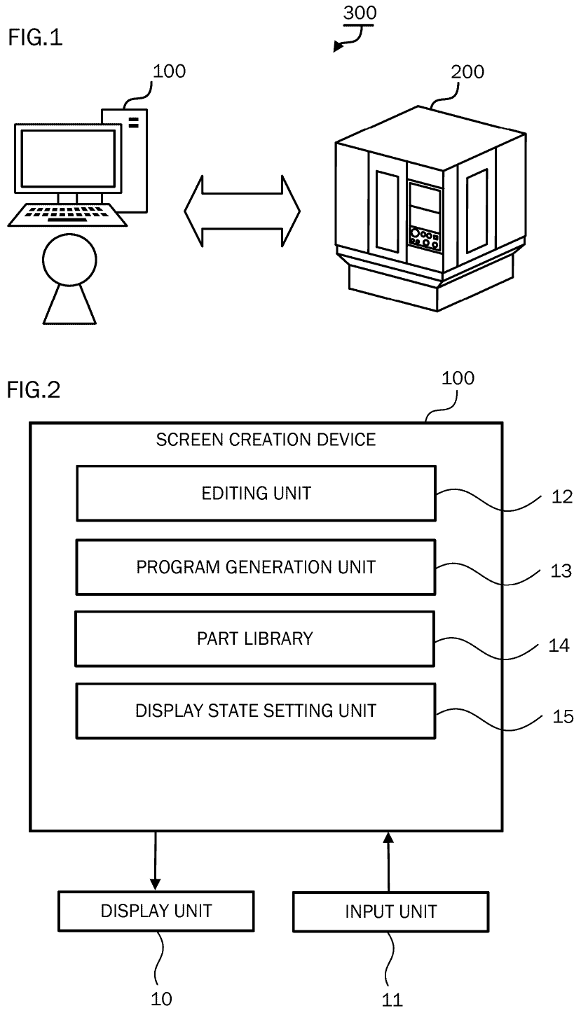

As illustrated in FIG. 1, the screen creation system 300 includes a screen creation device 100 and a numerical controller 200. For example, the screen creation device 100 is installed in an information processing device such as a PC (personal computer). Dedicated software for creating an operation screen of the numerical controller 200 is installed in the screen creation device 100. A user operates software to create a UI screen. The UI screen created by dedicated software is transferred to the numerical controller 200 and displayed on the numerical controller 200.

FIG. 2 is a block diagram of the screen creation device 100 included in the screen creation system 300.

The screen creation device 100 includes a display unit 10, an input unit 11, an editing unit 12, a program generation unit 13, a part library 14, and a display state setting unit 15.

The editing unit 12 displays a UI editing screen 20 on the display unit 10 of the screen creation device 100 and receives an editing operation by the user. The editing unit 12 updates screen layout and properties (attributes and execution functions (operations)) of parts according to input of the user.

The program generation unit 13 converts the properties of the parts and layout of the UI screen created by the editing unit 12 into an executable program. The executable program is implemented in the numerical controller 200 and function as the UI screen.

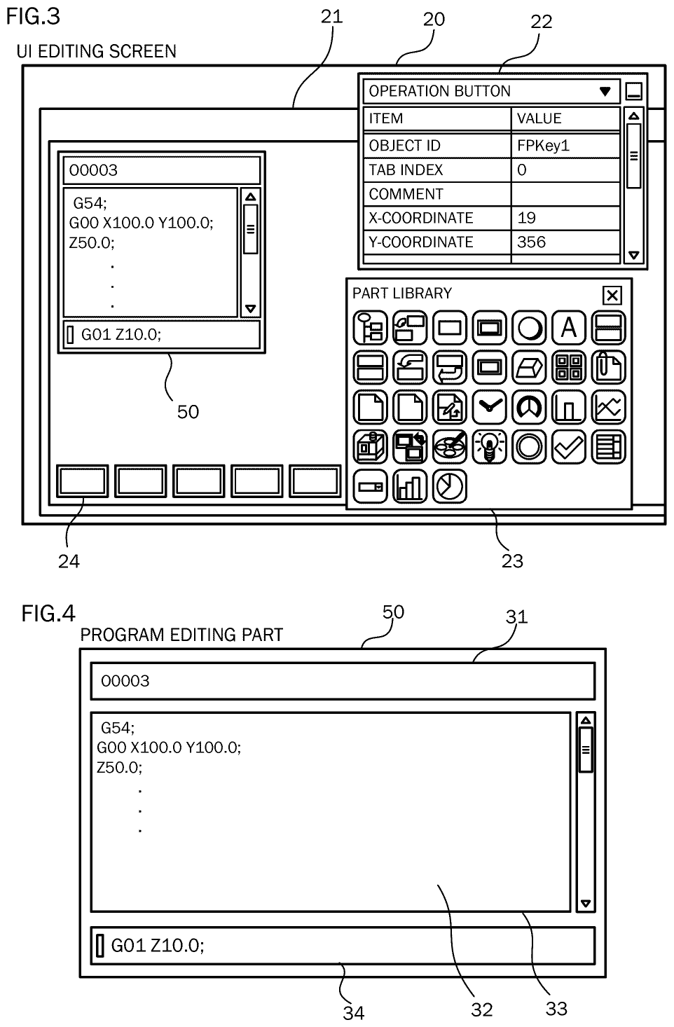

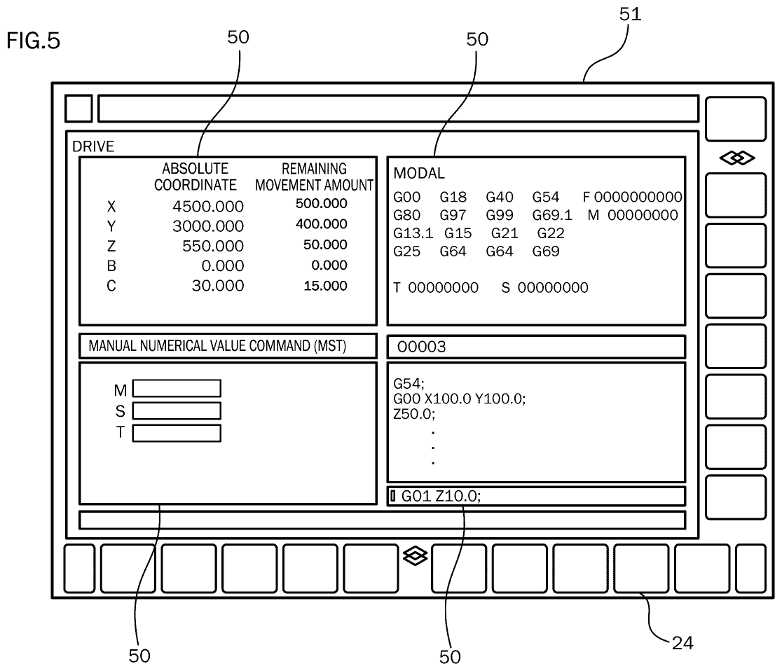

FIG. 3 is an example of the UI editing screen 20. The UI editing screen 20 of FIG. 3 includes a UI editing region 21, a property display region 22, and a part library display region 23. A part to be arranged on the UI screen can be selected from the part library display region 23. Five parts (operation buttons 24) are arranged on the UI editing region 21. One of the five operation buttons 24 is in a selected state. A property of the selected operation button 24 is displayed in the property display region 22.

In the property display region 22, information related to a part such as visual information such as a size, a shape, or coordinates of the part, a label such as a numerical value, an icon, or a character string displayed on the part, a type of part, a name of the part, and an operation (execution function) of the part can be set.

The part library 14 stores a part on the UI screen. The Part includes a single part and a composite part 50. The single part is an exclusive part. The single part includes the operation button 24, a key input button, a label, etc. However, the invention is not limited thereto.

The composite part 50 is a part obtained by combining a plurality of single parts.

The composite part 50 (program editing part) of FIG. 4 includes a plurality of single parts (a label display part 31, a figure display part 32, a multi-line character string display part 33, and an input reception part 34). The label display part 31 is a part that displays a character string. Here, a program name “00003” is displayed. The figure display part 32 is a part used for screen design. Here, a background is blue. The multi-line character string display part 33 is a part that displays a plurality of character strings. Here, a machining program is displayed in the multi-line character string display part 33. The input reception part 34 receives input of a character string to be edited. By pressing an “Enter” key, a character string input to the input reception part 34 is reflected in the multi-line character string display part 33.

A UI screen on which composite parts 50 are arranged will be described with reference to FIG. 5. A base part 51 and the composite parts 50 are arranged in a UI editing region 21 of FIG. 5. As illustrated in FIG. 5, operation buttons 24 for operating the UI screen are arranged in a region of a lower portion and a right portion of the base component 51. The composite parts 50 or a single part can be arranged in a central region of the base part 51.

Four composite parts 50 (a coordinate display part, an information display part, a manual numerical value command input part, and a program display part) are arranged in the base part 51 of FIG. 5. The operation buttons 24 of the base part 51 are associated with display states of the composite parts 50. A relationship between the operation buttons 24 and the composite parts 50 will be described later.

The display state setting unit 15 receives setting of an operation button 24 for a display state of a composite part 50, and creates display state information based on acquired information. The display state information associates the composite part 50, the display state of the composite part 50, and layout of the operation button 24 for each display state of the composite part 50. The display state of the composite part 50 includes at least one of a mode of the numerical controller 200, “display/non-display” of the composite part 50, and the “selection/non-selection” of the composite part 50.

The mode of the numerical controller 200 is a working state of the numerical controller 200. Examples of the mode of the numerical controller 200 include a mode set by an operator of the numerical controller 200, a mode automatically started by a signal of the numerical controller 200. Examples of the mode set by the operator include a memory mode and an MDI mode. Examples of the mode automatically generated include execution of an operation of workpiece coordinate measurement.

Note that “mode independent” in the following description means that the mode of the numerical controller 100 does not affect setting of the operation button 24.

Display of the composite part 50 means whether or not the composite part 50 included in the UI screen is displayed. There is more than one UI screen. Different composite parts 50 are arranged on a plurality of UI screens. Display/non-display of the composite part 50 changes depending on which UI screen is displayed.

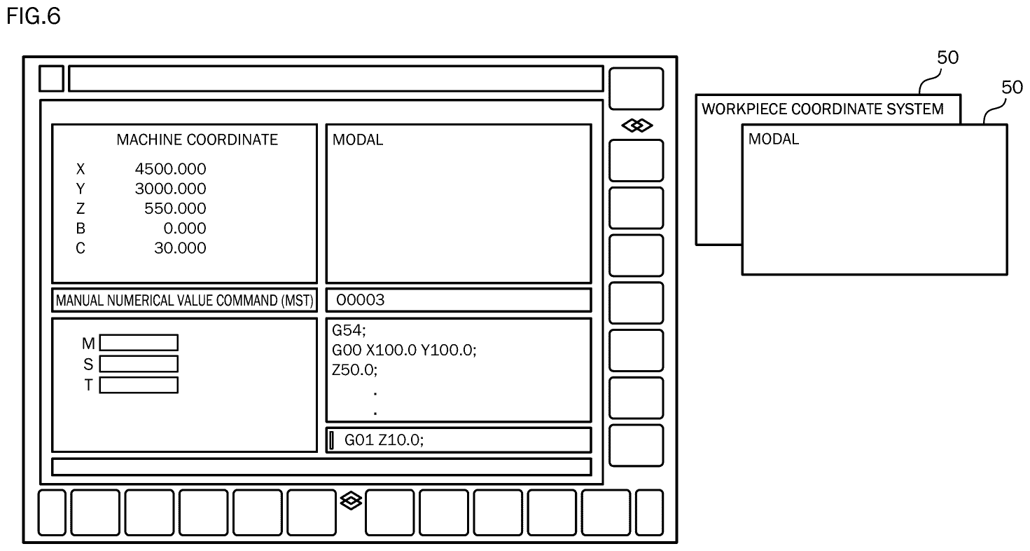

In addition, as illustrated in FIG. 6, two or more composite parts 50 may be overlapped and displayed in one display region of the UI screen. When one of the overlapping composite parts 50 is displayed, the other composite parts 50 are hidden.

Selection/non-selection of the composite part 50 means whether or not the composite part 50 included in the UI screen is selected. Selection/non-selection of the composite part 50 changes according to an operation of the operator. Note that “selection independent” in the following description means that selection/non-selection does not affect setting of the operation button 24.

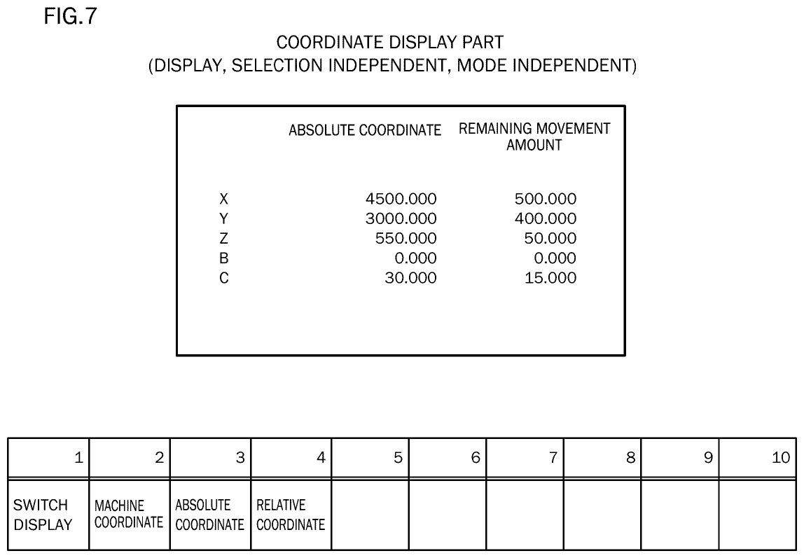

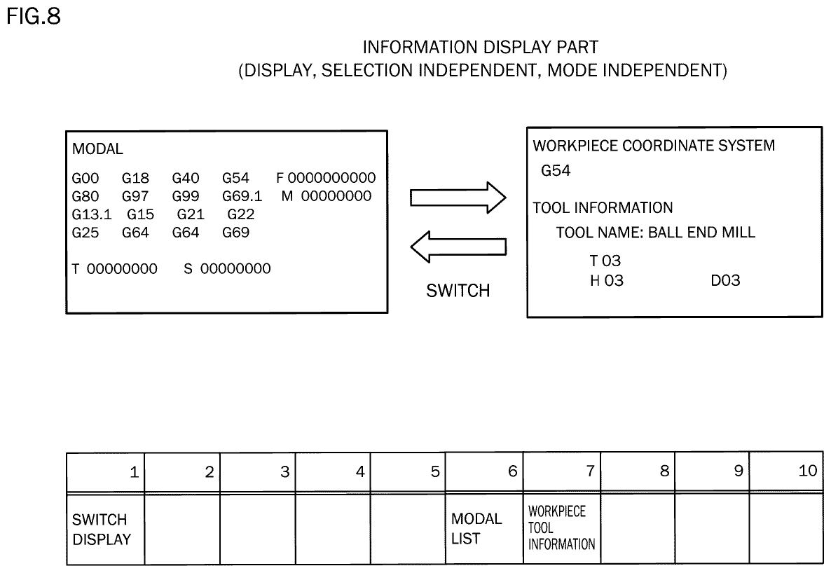

FIGS. 7 to 11 illustrate setting examples of the operation button 24 for each display state of the composite part 50.

As illustrated in FIG. 7, in the coordinate display part, four operation buttons 24 “switch display”, “machine coordinate”, “absolute coordinate” and “relative coordinate” are set for display states “display”, “selection independent”, and “mode independent”.

As illustrated in FIG. 8, in the information display part, three operation buttons 24 “switch display”, “modal list”, and “workpiece/tool information” are set for display states “display”, “selection independent”, and “mode independent”. The operation buttons 24 “modal list” and “workpiece/tool information” switch display of the information display part.

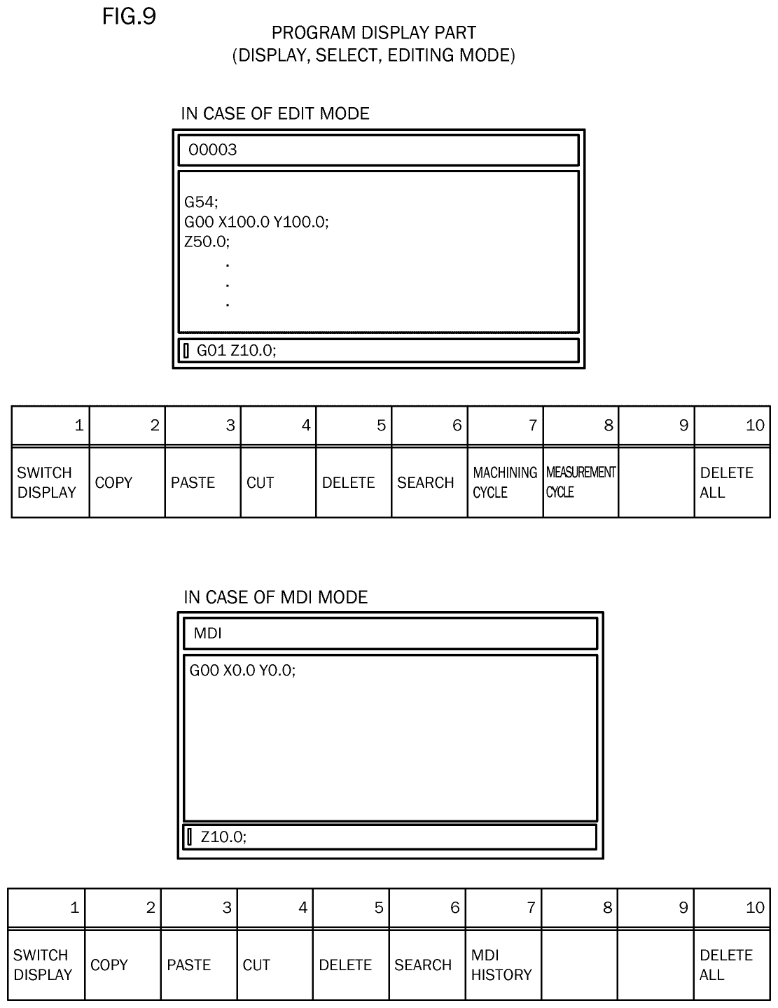

As illustrated in FIG. 9, in the program display part, different operation buttons 24 are set for each mode. In the program display part, nine operation buttons 24 “switch display”, “copy”, “paste”, “cut”, “delete”, “search”, “machining cycle”, “measurement cycle”, and “delete all” are set for display states “display”, “select”, “editing mode”. In display states “display”, “select”, and “MDI mode”, eight operation buttons 24 “switch display”, “copy”, “paste”, “cut”, “delete”, “search”, “MDI history”, and “delete all” are set.

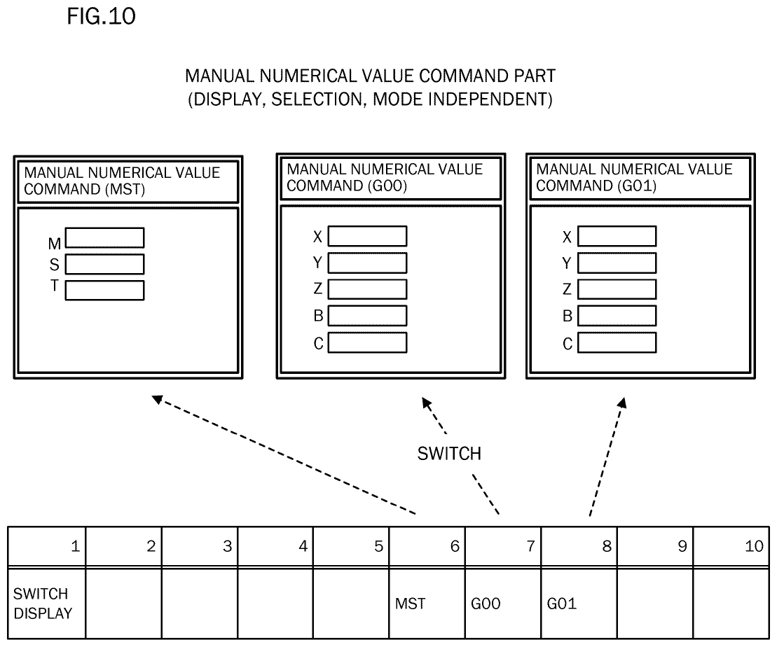

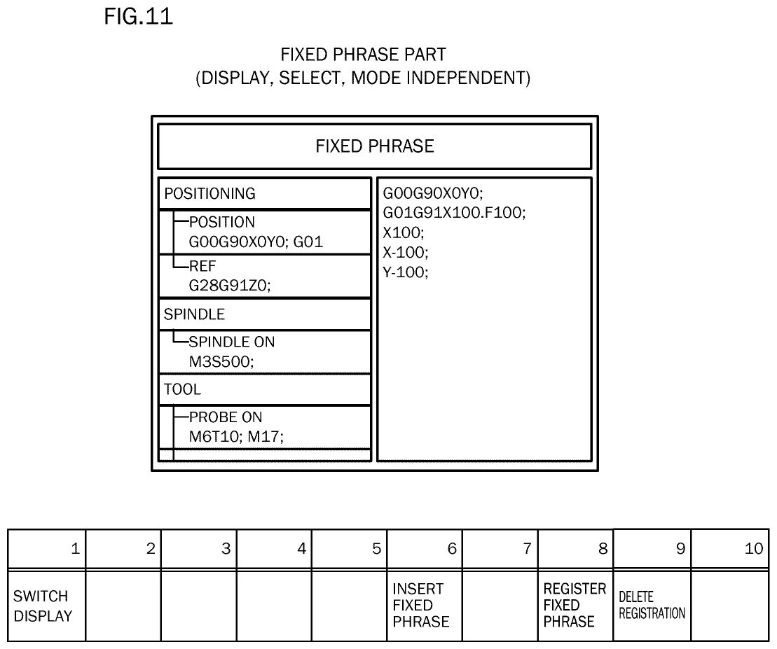

As illustrated in FIG. 10, in the manual numerical value command part, four operation buttons 24 “switch display”, “MST”, “G00”, and “G01” are set for display states “display”, “select”, and “mode independent”. The operation buttons 24 “MST”, “G00”, and “G01” switch display of the manual numerical value command part.

As illustrated in FIG. 11, in the fixed phrase part, four operation buttons 24 “switch display”, “insert fixed phrase”, “register fixed phrase”, and “delete registration of fixed phrase” are set for display states “display”, “select”, and “mode independent”. The operation buttons 24 “register fixed phrase”, “delete registration of fixed phrase”, and “insert fixed phrase” register and delete a fixed phrase and insert a registered fixed phrase into a program editing part.

In the screen creation system 300 of the present disclosure, the user sets an operation button 24 for each display state of the composite part 50 on the screen creation device 100. The numerical controller 200 automatically switches layout of an operation button 24 based on the operation button 24 for each display state set by the screen creation device 100 and an actual display state of the UI screen. The numerical controller 200 will be described below.

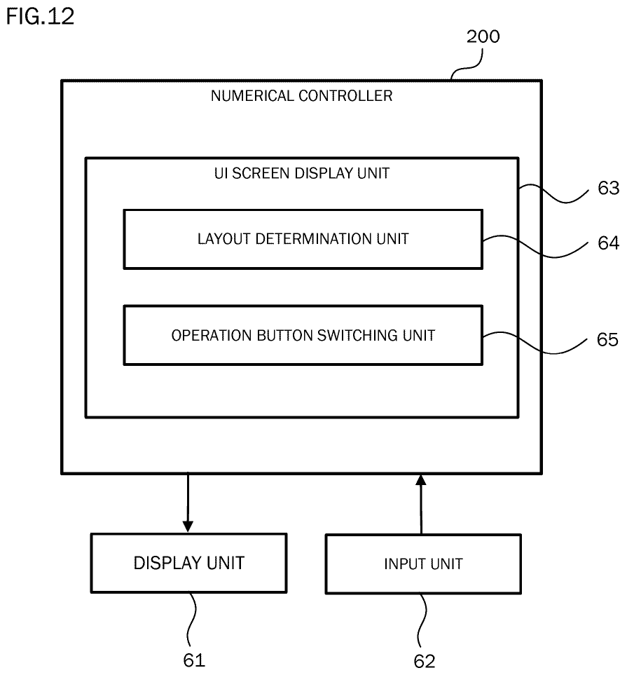

FIG. 12 is a block diagram of the numerical controller 200.

The numerical controller 200 includes a display unit 61, an input unit 62, a UI screen display unit 63, a layout determination unit 64, and an operation button switching unit 65.

The UI screen display unit 63 displays the UI screen created by the screen creation device 100 on the display unit 61 such as a display.

The layout determination unit 64 determines layout of the operation button 24 for each display state of the UI screen based on display state information. An example of a method of determining layout of the operation button 24 will be illustrated below. However, the method of determining layout is not limited thereto.

In a first method, when “selection/non-selection” is “selection” in the display state information, layout of the operation button 24 corresponding to this display state is set as layout of the operation button 24 on the UI screen. For example, in FIGS. 9 to 11, since an item “selection/non-selection” is “selection”, layout of the operation button 24 corresponding to this display state is set as layout of the operation button 24 on the UI screen.

In a second method, when there is a plurality of composite parts 50 of “display” and “selection independent” in the display state information, operations buttons 24 of composite parts 50 having the same “mode” are collectively arranged. When the operations buttons 24 are collectively arranged, the operations buttons 24 may be arranged so that there are no empty operations buttons 24 by being automatically arranged in right alignment or automatically arranged in left alignment, or the operations buttons 24 may be arranged at fixed positions. In the disclosure, the operations buttons 24 are arranged at fixed positions.

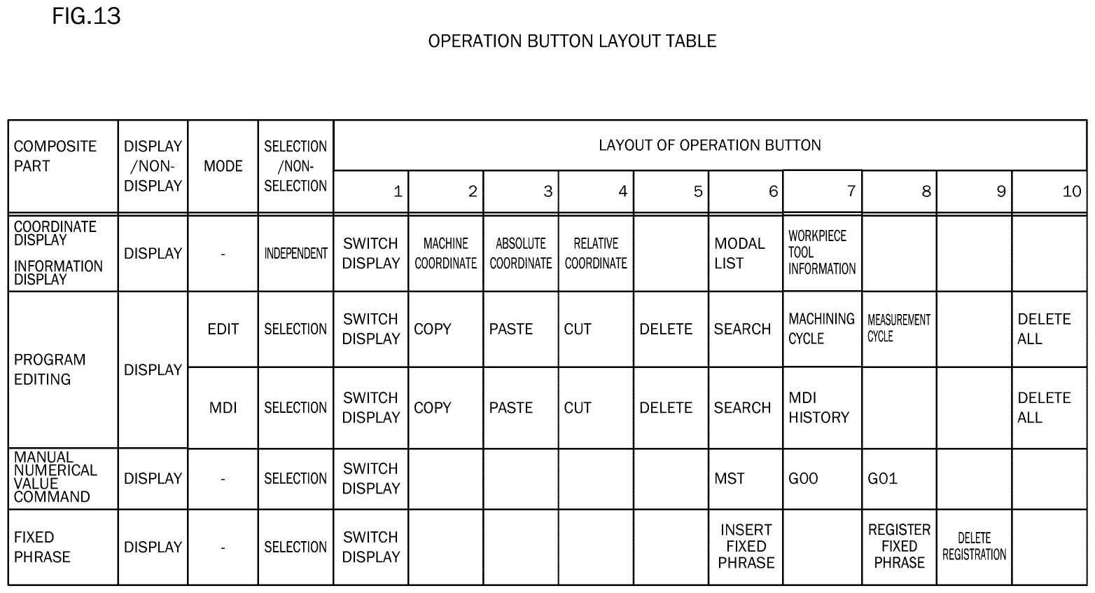

For example, since both the coordinate display part of FIG. 7 and the information display part of FIG. 8 are “display” and “mode independent”, as illustrated in a first line of FIG. 13, which will be described later, a combination of layout of the operation buttons 24 set in the coordinate display part and layout of the operation buttons 24 set in the information display part is set as layout of operation buttons 24 on the UI screen.

FIG. 13 is a determination result of the layout determination unit 64, which is referred to as an operation button layout table. The operation button layout table stores layout of the operation buttons 24 on the UI screen for each display state.

In the operation button layout table, a display state of each composite part 50 such as “name of the composite part”, “display/non-display”, “mode” of the numerical controller 200, or “selection/non-selection” is associated with “layout of the operation buttons” in the display state.

The operation button switching unit 65 detects changes in the display state (display/non-display of the composite part 50, the mode of the numerical controller 200, and selection/non-selection of the composite part 50) and switches layout of the operation buttons 24.

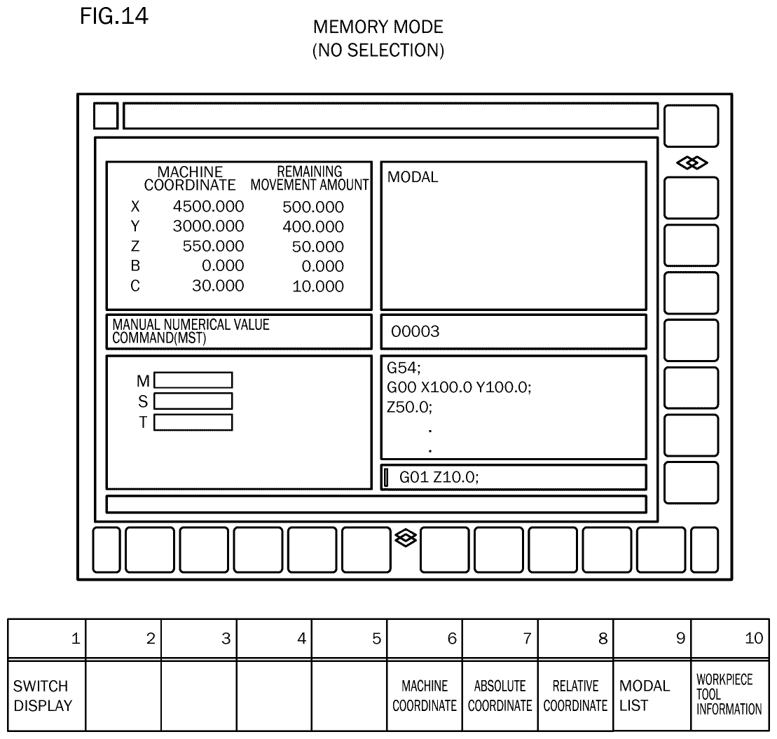

FIGS. 14 to 19 illustrate changes in layout of the operation buttons 24 on the UI screen.

When the numerical controller 200 is in “memory mode” and no composite part 50 is selected, as illustrated in FIG. 14, “machine coordinate”, “absolute coordinate” and “relative coordinate” are arranged as operation buttons 24 in the coordinate display part and operation buttons 24 of two composite parts 50 of “modal list” and “workpiece/tool information” are arranged as operation buttons 24 in the information display part are. Note that since the coordinate display part and the information display part are “mode independent”, the same operation buttons are arranged even when the mode is switched.

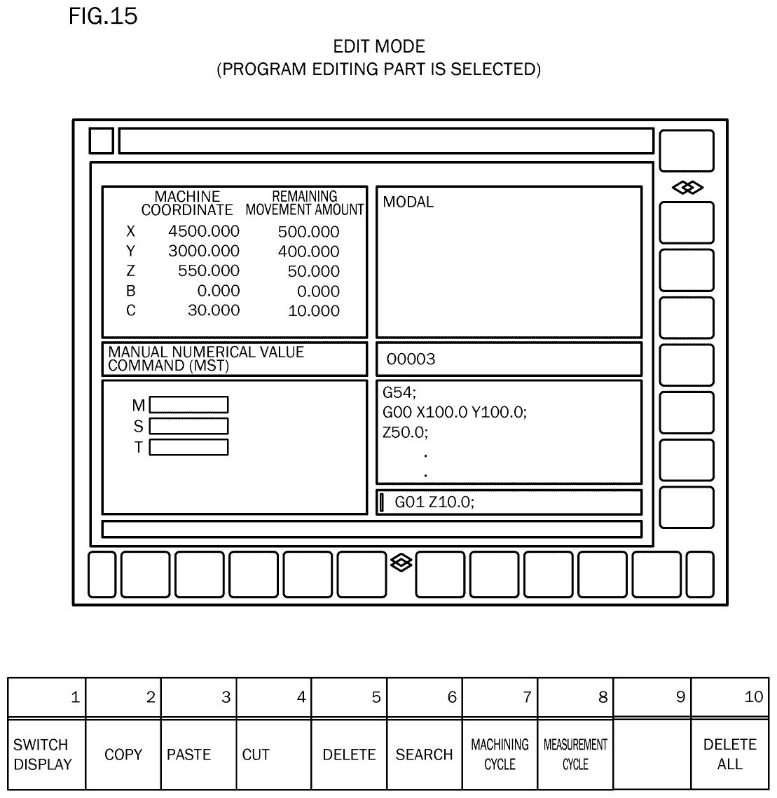

When the numerical controller 200 is in “editing mode” and the program editing part is selected, as illustrated in FIG. 15, “copy”, “paste”, “cut”, “delete”, “search”, “machining cycle”, “measurement cycle”, and “delete all” are arranged as operation buttons 24 in the program display part.

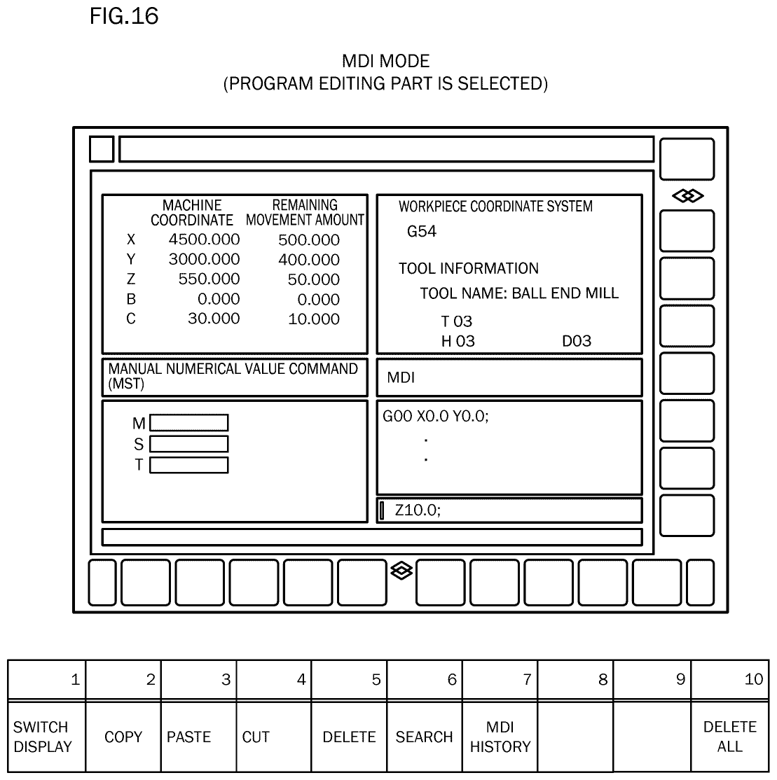

When the numerical controller 200 is in “MDI mode” and the program editing part is selected, as illustrated in FIG. 16, “copy”, “paste”, “cut”, “delete”, “search”, “MDI history”, and “delete all” are arranged as operation buttons 24 in the program editing part.

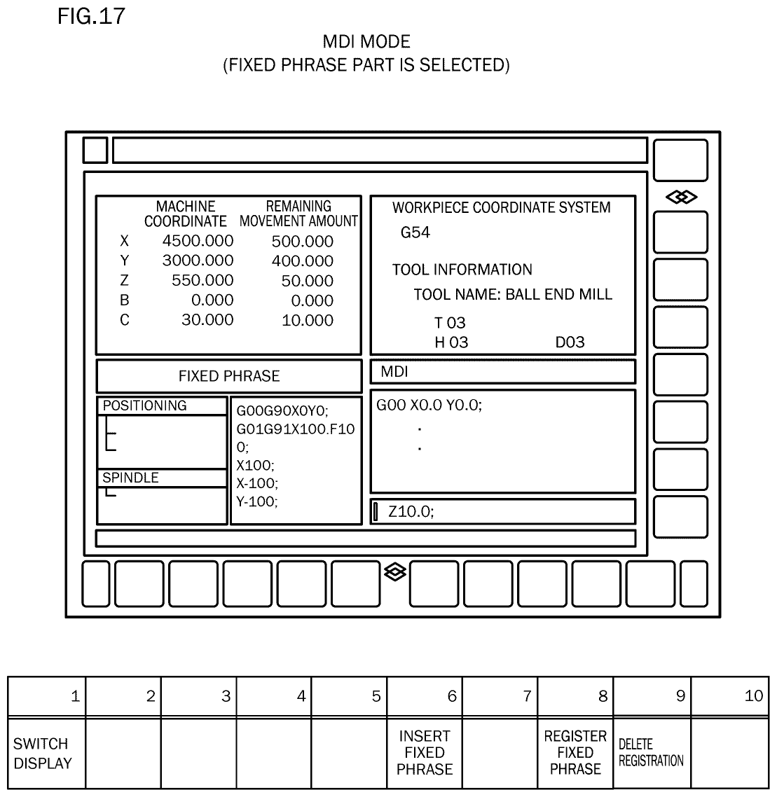

When the numerical controller 200 is in “MDI mode” and the fixed phrase part is selected, as illustrated in FIG. 17, “insert fixed phrase”, “register fixed phrase”, and “delete registration of fixed phrase” are arranged as operation buttons 24 in the fixed phrase part. Since the fixed phrase part is “mode independent”, the same operation buttons 24 are arranged even when the mode is switched.

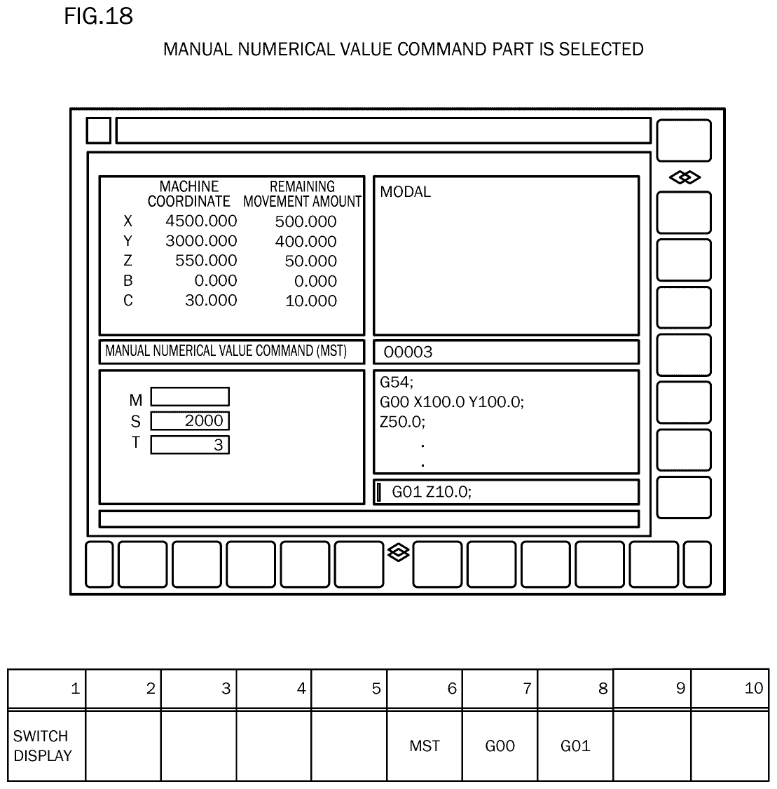

When the display state of the manual numerical value command part is “display” and “select”, as illustrated in FIG. 18, “switch display”, “MST”, “G00”, and “G01” are arranged as operation buttons 24. Since the manual numerical value command part is “mode independent”, the same operation buttons 24 are arranged even when the mode is changed.

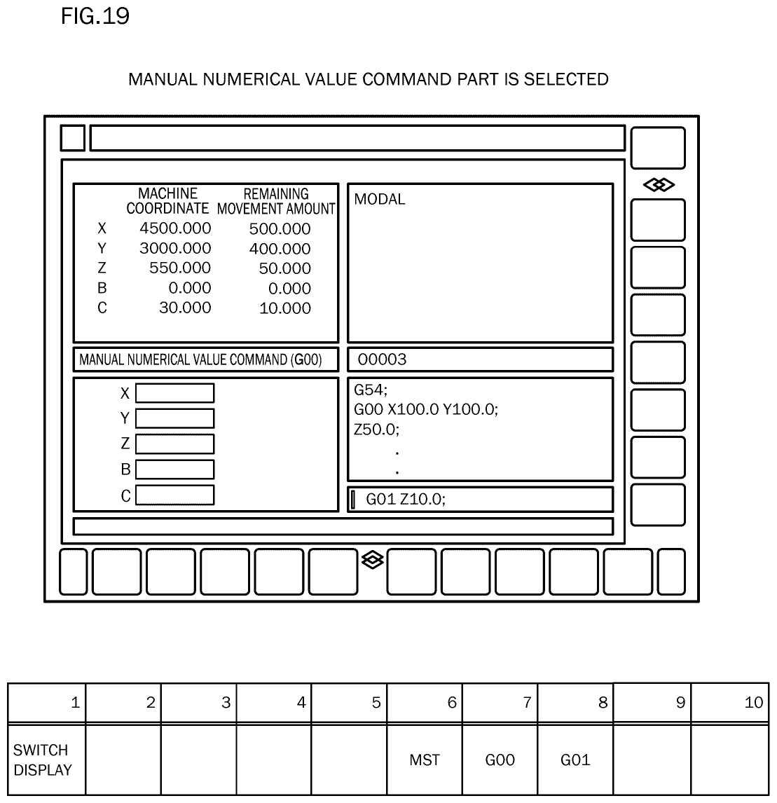

FIG. 18 illustrates the UI screen when the operation button 24 “MST” is pressed. When the operation button 24 “G00” of FIG. 18 is pressed, “manual numerical value command (MST)” is switched to “manual numerical value command (G00)” as illustrated in FIG. 19.

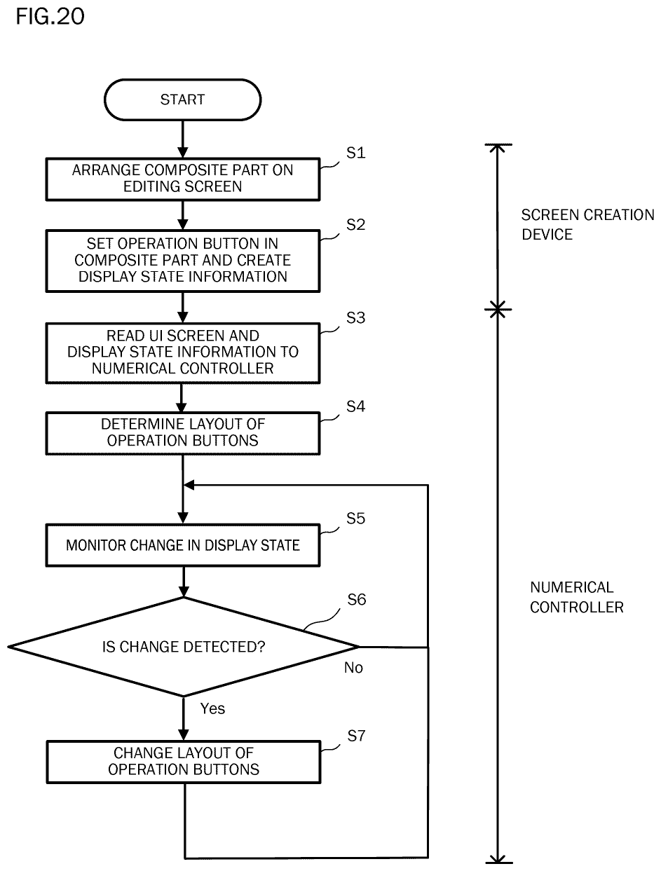

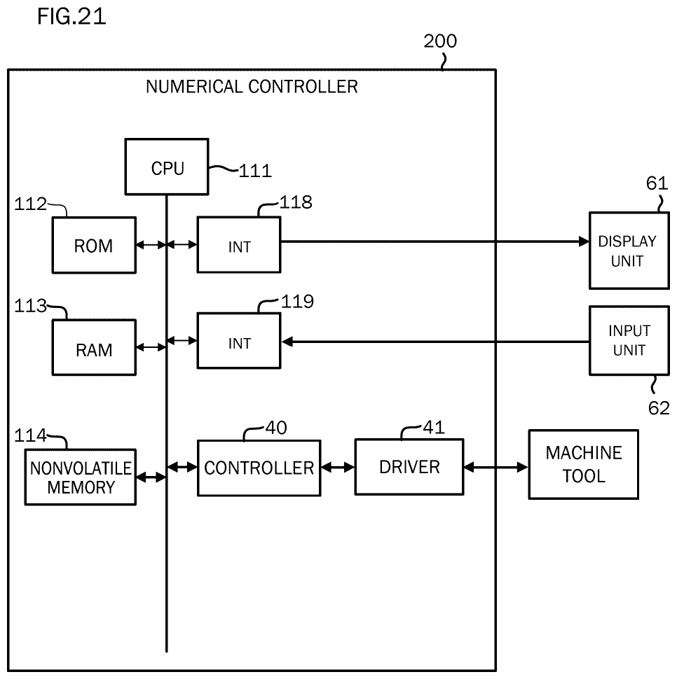

FIG. 20 is a flowchart illustrating an operation of the screen creation system 300 of the disclosure.

In the following flowchart, steps S1 to S2 are processes executed by the screen creation device 100, and steps S3 to S7 are processes executed by the numerical controller 200.

First, the composite part 50 is arranged on the UI editing screen 20 (step S1). The operation button 24 for each display state is set for the composite part 50 arranged on the UI screen to create display state information (step S2). As for the display state information, the operation button 24 in each display state of the composite part 50 is set. The display state includes a mode of the numerical controller 200, display/non-display of the composite part 50, selection/non-selection of the composite part 50, etc.

The numerical controller 200 reads the UI screen and the display state information created by the screen creation device 100 (step S3). Based on the display state information, the numerical controller 200 determines layout of the operation button 24 in each display state of the UI screen and creates a layout table of the operation buttons 24 on the UI screen (step S4).

The numerical controller 200 displays the UI screen created by the screen creation device 100 and monitors a change in the display state (step S5). Upon detecting an operation of the operator or a change in the display state by an internal signal of the numerical controller 200 (step S6; Yes), the numerical controller 200 changes layout of the operation buttons 24 according to the change in the display state (step S7). When layout of the operation buttons 24 is changed, the process proceeds to step S5 to continue monitoring.

When the display state does not change (step S6; No), the process proceeds to step S5 to continue monitoring.

As described above, in the screen creation system 300 of the disclosure, when the operation button 24 in each display state of the composite part 50 is set, the numerical controller 200 determines layout of the operation button 24 for each display state of the UI screen. The numerical controller 200 detects a change in the display state and automatically changes layout of the operation button 24.

The screen creation system 300 of the disclosure facilitates creation of the UI screen. Setting of the operation button 24 for each composite part 50 can be reused in a different UI screen, which is more convenient than setting layout of the operation button 24 for each UI screen.

### [Hardware Configuration]

A hardware configuration of the numerical controller will be described with reference to FIG. 21. A CPU 111 included in the numerical controller 200 is a processor that controls the entire numerical controller 200. The CPU 111 reads a system program processed in a ROM 112 via a bus and controls the entire numerical controller 200 according to the system program. Temporary calculation data or display data, various data input by the user via an input unit 62, etc. are temporarily stored in a RAM 113.

A display unit 61 is, for example, a monitor attached to the numerical controller 200. The display unit 61 displays an operation screen, a setting screen, etc. of the numerical controller 200.

The input unit 62 is integrated with the display unit 61 or is a keyboard, a touch panel, etc. separate from the display unit 61. The user operates the input unit 62 to perform input to a screen displayed on the display unit 61, etc. Note that the display unit 61 and the input unit 62 may be mobile terminals.

A nonvolatile memory 114 is, for example, a memory that is backed up by a battery (not illustrated) so that a storage state is retained even when the power of the numerical controller 200 is turned off. A program read from an external device via an interface (not illustrated), a program input via the input unit 62, and various data acquired from each unit of the numerical controller 200, a machine tool, etc. (for example, a setting parameter acquired from the machine tool, etc.) are stored in the nonvolatile memory 114. The program and the various data stored in the nonvolatile memory 114 may be loaded in the RAM 113 during execution/use. In addition, various system programs are written to the ROM 112 in advance.

A controller 40 for controlling a tool of the machine tool converts an axis movement command from the CPU 111 into a pulse signal and outputs the pulse signal to a driver 41. The driver 41 converts the pulse signal into a current to drive a servomotor of the machine tool. The servomotor moves the tool or a table under the control of the numerical controller 200.

The screen creation device 100 does not include the controller 40 and the driver 41, but has substantially the same hardware configuration as that of FIG. 20. A description of the hardware configuration of the screen creation device 100 is omitted.

### EXPLANATIONS OF LETTERS OR NUMERALS

100 SCREEN CREATION DEVICE
200 NUMERICAL CONTROLLER
300 SCREEN CREATION SYSTEM
10 DISPLAY UNIT
11 INPUT UNIT
12 EDITING UNIT
13 PROGRAM GENERATION UNIT
14 PART LIBRARY
50 COMPOSITE PART
61 DISPLAY UNIT
62 INPUT UNIT
63 UI SCREEN DISPLAY UNIT
64 LAYOUT DETERMINATION UNIT
65 OPERATION BUTTON SWITCHING UNIT
111 CPU
112 ROM
113 RAM
114 NONVOLATILE MEMORY

1. A numerical controller for displaying a user interface screen, the numerical controller comprising:
a layout determination unit configured to acquire display state information obtained by associating a composite part included in the user interface screen, a display state of the composite part, and setting of an operation button, and determine a layout of an operation button for each display state of the user interface screen including the composite part based on the display state of the composite part and setting of the operation button; and
an operation button switching unit configured to detect a change in the display state of the user interface screen, and switch layout of the operation button on the user interface screen based on determination of the layout determination unit.

2. The numerical controller according to claim 1, wherein the display state includes information on whether or not the composite part is displayed.

3. The numerical controller according to claim 1, wherein the display state includes a mode of the numerical controller.

4. The numerical controller according to claim 1, wherein the display state includes information on whether or not the composite part is selected.

5. A screen creation system comprising:
a part library configured to store parts included in a user interface screen and a composite part obtained by combining the parts;
a display state setting unit configured to receive setting of display state information obtained by associating a composite part included in the user interface screen, a display state of the composite part, and setting of an operation button with respect to the composite part;
a layout determination unit configured to determine layout of the operation button for each display state of the user interface screen including the composite part based on the display state of the composite part and setting of the operation button; and
an operation button switching unit configured to detect a change in the display state of the user interface screen, and change layout of the operation button displayed on the UI screen in a numerical controller based on determination of the layout determination unit.

6. A storage medium storing an instruction readable by a numerical controller, the instruction being executed by one or a plurality of processors to:
acquire display state information obtained by associating a composite part included in a user interface screen of the numerical controller, a display state of the composite part, and setting of an operation button with respect to the composite part;
determine layout of the operation button for each display state of the user interface screen including the composite part based on setting of the operation button for each display state of the composite part;
detect a change in the display state of the user interface screen; and
switch layout of the operation button according to the display state of the user interface screen.
